(19) United States
(12) Patent Application Publication
(10) Pub. No.: US 2017/0367024 A1
(43) Pub. Date: Dec. 21, 2017

(54) Update of a Mobility Parameter in a System Configured for Dual Connectivity

(71) Applicant: Nokia Solutions and Networks, Espoo (FI)

(72) Inventors: Tsunehiko CHIBA, Saitama (JP); Srinivasan SELVAGANAPATHY, Bangalore (IN)

(21) Appl. No.: 15/532,628

(22) PCT Filed: Dec. 3, 2015
(86) PCT No.: PCT/EP2015/078530

§ 371 Date: Jun. 2, 2017

(30) Foreign Application Priority Data
Dec. 5, 2014 (IN) 3544/DEL/2014

(51) Int. Cl. H04W 36/28; H04W 24/02; H04W 36/18; H04W 36/22

(52) U.S. Cl. CPC H04W 36/28; H04W 36/22; H04W 24/02; H04W 36/18

(57) ABSTRACT

A method including storing, at a first node, at least one parameter associated with handover of one or more user equipment from said first node to at least one further node; causing to be sent, from said first node, a request for change of said parameter; and updating said parameter at said first node; wherein said first node is configured for dual connectivity with one or more user equipment and a second node.

### BACKGROUND

The present application relates to a method, apparatus, computer program and system and in particular but not exclusively, some embodiments may relate to a method, apparatus and computer program for use, for example in dual connectivity scenarios.

A communication system can be seen as a facility that enables communication sessions between two or more entities such as fixed or mobile communication devices, base stations, servers and/or other communication nodes. A communication system, and compatible communicating entities, typically operate in accordance with a given standard or specification which sets out what the various entities associated with the system are permitted to do and how that should be achieved. For example, the standards, specifications and related protocols can define the manner how various aspects of communication shall be implemented between communicating devices. A communication can be carried on wired or wireless carriers. In a wireless communication system at least a part of communications between stations occurs over a wireless link.

Examples of wireless systems include public land mobile networks (PLMN) such as cellular networks, satellite based communication systems and different wireless local networks, for example wireless local area networks (WLAN). A wireless system can be divided into cells or other radio coverage or service areas. A radio service area is provided by a station. Radio service areas can overlap, and thus a communication device in an area can typically send signals to and receive signals from more than one station.

A user can access the communication system by means of an appropriate communication device. A communication device of a user is often referred to as user equipment (UE) or terminal. A communication device is provided with an appropriate signal receiving and transmitting arrangement for enabling communications with other parties. Typically a communication device is used for enabling receiving and transmission of communications such as speech and data. In wireless systems a communication device provides a transceiver station that can communicate with another communication device such as e.g. a base station or an access point and/or another user equipment. The communication device may access a carrier provided by a station, for example a base station or an access node, and transmit and/or receive communications on the carrier.

An example of communication systems is an architecture that is being standardized by the 3rd Generation Partnership Project (3GPP). This system is often referred to as the long-term evolution (LTE) of the Universal Mobile Telecommunications System (UMTS) radio-access technology. A further development of the LTE is often referred to as LTE-Advanced. The various development stages of the 3GPP LTE specifications are referred to as releases.

A communication system can comprise different types of radio service areas providing transmission/reception points for the users. For example, in LTE-Advanced the transmission/reception points can comprise wide area network nodes such as a macro eNode-B (eNB) which may, for example, provide coverage for an entire cell or similar radio service area. Network nodes can also be small or local radio service area network nodes, for example Home eNBs (HeNB), pico eNodeBs (pico-eNB), or femto nodes. Some applications utilise radio remote heads (RRH) that are connected to for example an eNB. The smaller radio service areas can be located wholly or partially within the larger radio service area. A user equipment may thus be located within, and thus communicate with, more than one radio service area. The nodes of the smaller radio service areas may be configured to support local offload. The local nodes can also, for example, be configured to extend the range of a cell.

### SUMMARY

According to a first aspect there is provided a method comprising: storing, at a first node, at least one parameter associated with handover of one or more user equipment from said first node to at least one further node; causing to be sent, from said first node, a request for change of said parameter; and updating said parameter at said first node; wherein said first node is configured for dual connectivity with one or more user equipment and a second node.

According to some embodiments, said first node comprises a base station controlling a first secondary cell, and said second node comprises a base station controlling a master cell.

According to some embodiments, said at least one further node comprises a base station controlling a second secondary cell.

According to some embodiments, said parameter comprises a cell-loading threshold.

According to some embodiments, said updating said parameter comprises one of: reducing said cell-loading threshold; increasing said cell-loading threshold.

According to some embodiments, said request is sent to at least one of: said at least one further node; said second node.

According to some embodiments, the method comprises receiving a response to said request authorizing said requested change of said parameter, said updating said parameter at said first node being in response to receiving said authorization.

According to some embodiments, said first node is also configured for single connectivity with one or more user equipment.

According to a second aspect there is provided a computer program comprising computer executable instructions which when run on one or more processors perform the method of the first aspect.

According to a third aspect there is provided a method comprising: storing, at a node, at least one parameter associated with handover of one or more user equipment from a first node to at least one further node; receiving, from said first node, a request for change of said parameter; and updating said parameter at said node; wherein said node is configured for dual connectivity with one or more user equipment and a second node.

According to some embodiments, said node at which said parameter is stored comprises one of: said at least one further node; said second node.

According to some embodiments, said at least one further node comprises a base station controlling a second secondary cell, and said second node comprises a base station controlling a master cell.

According to some embodiments, said first node comprises a base station controlling a first secondary cell.

According to some embodiments, said parameter comprises a cell-loading threshold.

According to some embodiments, said updating said parameter comprises one of: reducing said cell-loading threshold; increasing said cell-loading threshold.

According to some embodiments, the method comprises sending a response to said request authorizing said requested change of said parameter.

According to some embodiments, said node is also configured for single connectivity with one or more user equipment.

According to some embodiments, said second node is also configured for single connectivity with one or more user equipment.

According to a fourth aspect there is provided a computer program comprising computer executable instructions which when run on one or more processors perform the method of the third aspect.

According to a fifth aspect there is provided an apparatus comprising: at least one processor; and at least one memory including computer program code; the at least one memory and the computer program code configured to, with the at least one processor, cause the apparatus at least to: store at least one parameter associated with handover of one or more user equipment from said apparatus to at least one further node; cause to be sent, from said apparatus, a request for change of said parameter; and update said parameter at said apparatus; wherein said apparatus is configured for dual connectivity with one or more user equipment and a second node.

According to some embodiments, said apparatus comprises a base station controlling a first secondary cell, and said second node comprises a base station controlling a master cell.

According to some embodiments, said at least one further node comprises a base station controlling a second secondary cell.

According to some embodiments, said parameter comprises a cell-loading threshold.

According to some embodiments, said updating said parameter comprises one of: reducing said cell-loading threshold; increasing said cell-loading threshold.

According to some embodiments, said apparatus is configured to send said request to at least one of: said at least one further node; said second node.

According to some embodiments, the apparatus is configured to receive a response to said request authorizing said requested change of said parameter, said updating said parameter at said apparatus being in response to receiving said authorization.

According to some embodiments, said apparatus is also configured for single connectivity with one or more user equipment.

According to a sixth aspect there is provided an apparatus comprising: at least one processor; and at least one memory including computer program code; the at least one memory and the computer program code configured to, with the at least one processor, cause the apparatus at least to: store at least one parameter associated with handover of one or more user equipment from a first node to at least one further node; receive, from said first node, a request for change of said parameter; and update said parameter at said apparatus; wherein said apparatus is configured for dual connectivity with one or more user equipment and a second node.

According to some embodiments, said apparatus at which said parameter is stored comprises one of: said at least one further node; said second node.

According to some embodiments, said at least one further node comprises a base station controlling a second secondary cell, and said second node comprises a base station controlling a master cell.

According to some embodiments, said first node comprises a base station controlling a first secondary cell.

According to some embodiments, said parameter comprises a cell-loading threshold.

According to some embodiments, said updating said parameter comprises one of: reducing said cell-loading threshold; increasing said cell-loading threshold.

According to some embodiments, the apparatus is configured to send a response to said request authorizing said requested change of said parameter.

According to some embodiments, said apparatus is also configured for single connectivity with one or more user equipment.

According to some embodiments, said second node is also configured for single connectivity with one or more user equipment.

According to a seventh aspect there is provided an apparatus comprising means for storing at least one parameter associated with handover of one or more user equipment from said apparatus to at least one further node; means for causing to be sent, from said apparatus, a request for change of said parameter; and means for updating said parameter at said apparatus; wherein said apparatus comprises means for dual connectivity with one or more user equipment and a second node.

According to some embodiments, said apparatus comprises a base station controlling a first secondary cell, and said second node comprises a base station controlling a master cell.

According to some embodiments, said at least one further node comprises a base station controlling a second secondary cell.

According to some embodiments, said parameter comprises a cell-loading threshold.

According to some embodiments, said updating said parameter comprises one of: reducing said cell-loading threshold; increasing said cell-loading threshold.

According to some embodiments, said apparatus comprises means for sending said request to at least one of: said at least one further node; said second node.

According to some embodiments, the apparatus comprises means for receiving a response to said request authorizing said requested change of said parameter, said updating said parameter at said apparatus being in response to receiving said authorization.

According to some embodiments, said apparatus also comprises means for single connectivity with one or more user equipment.

According to an eighth aspect there is provided an apparatus comprising: means for storing at least one parameter associated with handover of one or more user equipment from a first node to at least one further node; means for receiving, from said first node, a request for change of said parameter; and means for updating said parameter at said apparatus; wherein said apparatus comprises means for dual connectivity with one or more user equipment and a second node.

According to some embodiments, said apparatus at which said parameter is stored comprises one of: said at least one further node; said second node.

According to some embodiments, said at least one further node comprises a base station controlling a second secondary cell, and said second node comprises a base station controlling a master cell.

According to some embodiments, said first node comprises a base station controlling a first secondary cell.

According to some embodiments, said parameter comprises a cell-loading threshold. According to some embodiments, said updating said parameter comprises one of: reducing said cell-loading threshold; increasing said cell-loading threshold.

According to some embodiments, the apparatus comprises means for sending a response to said request authorizing said requested change of said parameter.

According to some embodiments, said apparatus also comprises means for single connectivity with one or more user equipment.

According to some embodiments, said second node also comprises means for single connectivity with one or more user equipment.

### BRIEF DESCRIPTION OF FIGURES

Some embodiments will now be described by way of example only with reference to the accompanying figures in which:

FIG. 1 shows a schematic diagram of a network according to some embodiments;

FIG. 2 shows a schematic diagram of a mobile communication device according to some embodiments;

FIG. 3 shows control-plane connectivity of eNBs involved in dual connectivity;

FIG. 4 shows user-plane connectivity of eNBs involved in dual connectivity;

FIG. 5 is a signalling diagram according to an embodiment;

FIG. 6 is a signalling diagram according to an embodiment;

FIG. 7 shows an example load balancing scenario;

FIG. 8 is a signalling diagram according to an embodiment;

FIG. 9 shows another example load balancing scenario;

FIG. 10 is a signalling diagram according to an embodiment;

FIG. 11 shows a schematic diagram of a control apparatus according to some embodiments.

FIG. 12 shows a flow chart according to an embodiment;

FIG. 13 shows a flow chart according to an embodiment.

### DETAILED DESCRIPTION

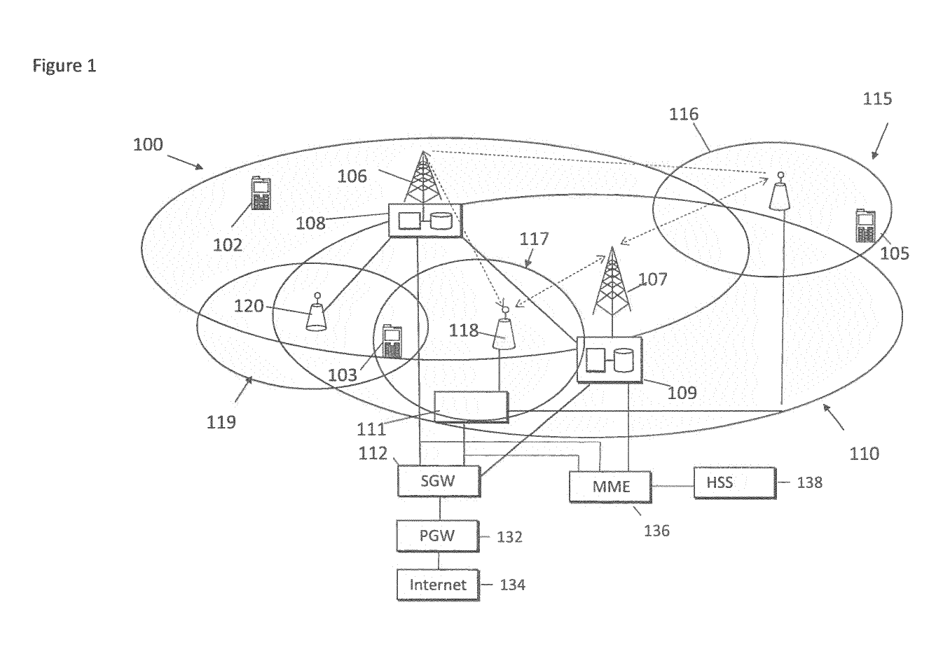

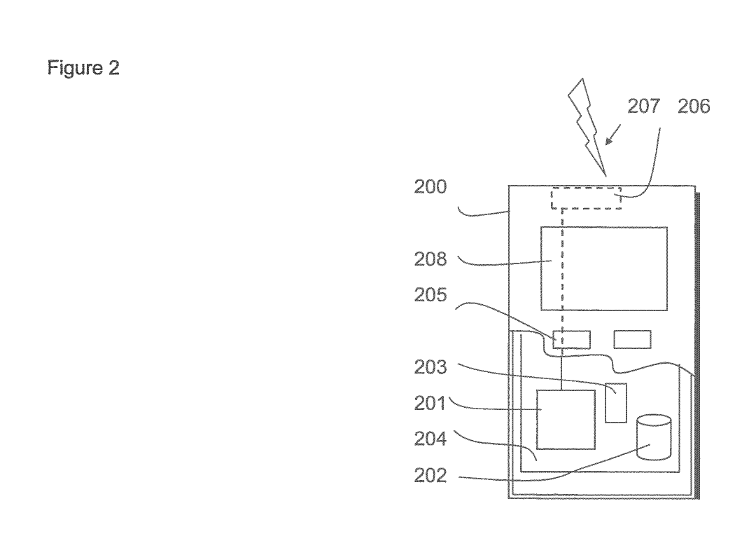

In the following certain exemplifying embodiments are explained with reference to a wireless or mobile communication system serving mobile communication devices. Before explaining in detail the exemplifying embodiments, certain general principles of a wireless communication system and mobile communication devices are briefly explained with reference to FIGS. 1 and 2 to assist in understanding the technology underlying the described examples.

In a wireless communication system mobile communication devices or user equipment (UE) 102, 103, 105 are provided wireless access via at least one base station or similar wireless transmitting and/or receiving node or point. In the FIG. 1 example two overlapping access systems or radio service areas of a cellular system 100 and 110 and three smaller radio service areas 115, 117 and 119 provided by base stations 106, 107, 116, 118 and 120 are shown. Each mobile communication device and station may have one or more radio channels open at the same time and may send signals to and/or receive signals from more than one source. It is noted that the radio service area borders or edges are schematically shown for illustration purposes only in FIG. 1. It shall also be understood that the sizes and shapes of radio service areas may vary considerably from the shapes of FIG. 1. A base station site can provide one or more cells. A base station can also provide a plurality of sectors, for example three radio sectors, each sector providing a cell or a subarea of a cell. All sectors within a cell can be served by the same base station.

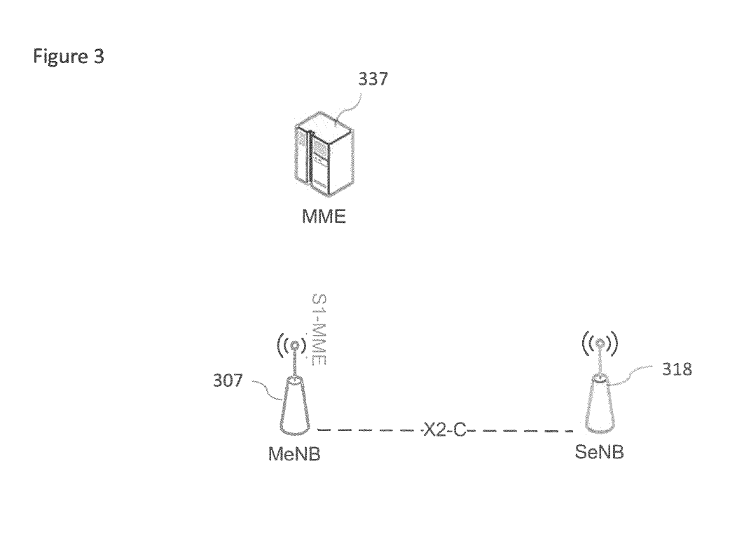

Base stations are typically controlled by at least one appropriate controller apparatus so as to enable operation thereof and management of mobile communication devices in communication with the base stations. In FIG. 1 control apparatus 108 and 109 is shown to control the respective macro level base stations 106 and 107. The control apparatus of a base station can be interconnected with other control entities. The control apparatus is typically provided with memory capacity and at least one data processor. The control apparatus and functions may be distributed between a plurality of control units. The control apparatus may be as shown in FIG. 3 which is discussed later.

In FIG. 1 stations 106 and 107 are shown as connected to a serving gateway (SGW) 112. The smaller stations 116, 118 and 120 are connected to a further gateway function 111 which is connected to the S-GW 112. In some embodiments, the further gateway function 111 is omitted. The S-GW 112 may be connected to, for example, the internet 134 via a PGW (PDN (packet data network) gateway) 132.

The base stations are also connected to a MME 136 (mobility management entity) which in turn is connected to a HSS (home subscriber server) 138.

A possible mobile communication device for transmitting and retransmitting information blocks towards the stations of the system will now be described in more detail with reference to FIG. 2 showing a schematic, partially sectioned view of a communication device 200. Such a communication device is often referred to as user equipment (UE) or terminal. An appropriate mobile communication device may be provided by any device capable of sending and receiving radio signals. Non-limiting examples include a mobile station (MS) such as a mobile phone or what is known as a ‘smart phone’, a computer provided with a wireless interface card or other wireless interface facility, personal data assistant (PDA) provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services include two-way or multi-way calls, data communication or multimedia services or simply an access to a data communications network system, such as the Internet. Users may also be provided broadcast or multicast data. Non-limiting examples of the content include downloads, television and radio programs, videos, advertisements, various alerts and other information. The mobile device 200 may receive signals over an air interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

A wireless communication device can be provided with a Multiple Input/Multiple Output (MIMO) antenna system. MIMO arrangements as such are known. MIMO systems use multiple antennas at the transmitter and receiver along with advanced digital signal processing to improve link quality and capacity. Although not shown in FIGS. 1 and 2, multiple antennas can be provided, for example at base stations and mobile stations, and the transceiver apparatus 206 of FIG. 2 can provide a plurality of antenna ports. More data can be received and/or sent where there are more antenna elements. A station may comprise an array of multiple antennas. Signalling and muting patterns can be associated with Tx antenna numbers or port numbers of MIMO arrangements.

A mobile device is also typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

The communication devices 102, 103, 105 can access the communication system based on various access techniques, such as code division multiple access (CDMA), or wideband CDMA (WCDMA). Other examples include time division multiple access (TDMA), frequency division multiple access (FDMA) and various schemes thereof such as the interleaved frequency division multiple access (IFDMA), single carrier frequency division multiple access (SC-FDMA) and orthogonal frequency division multiple access (OFDMA), space division multiple access (SDMA) and so on.

Dual connectivity (DC) is a feature currently under standardization for Rel-12 of the 3GGP EUTRA specifications. The basic principle of DC is that a UE is able to simultaneously receive/transmit data from/to two eNBs, a master eNB (MeNB) and a secondary eNB (SeNB), operating at different carrier frequencies. In dual connectivity the MeNB acts as a mobility anchor towards the core network (CN).The MCG refers to the group of serving cells associated with the MeNB, and the SCG refers to the group of serving cells associated with the SeNB. The main difference between DC and carrier aggregation (CA) is that the MeNB and the SeNB are assumed to be connected via a non-ideal backhaul link (X2) characterized by transmission delays (in the range of ˜2-30 ms) and limited capacity. User plane (U-plane) options can be distinguished depending on whether they allow bearer split or not. Bearer split refers to the ability to split a bearer over multiple eNBs. Without bearer split, a bearer is only transmitted by one eNB. From C-plane perspective, the RRC entity only resides in the MeNB.

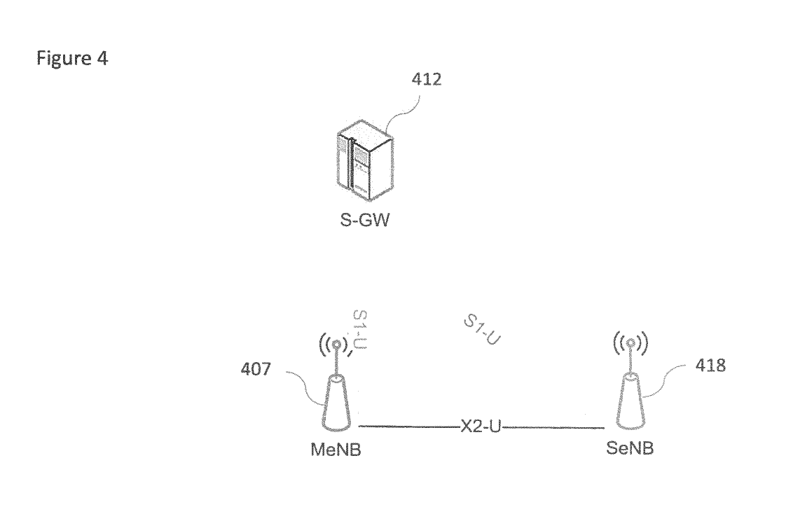

Dual connectivity is explained in more detail with respect to FIGS. 3 and 4.

FIG. 3 shows C-plane (control plane) connectivity of eNBs involved in dual connectivity. FIG. 3 shows a MME 337 connected to a MeNB 307 over a S1-MME interface. The MeNB 307 is connected to a SeNB 318 over an X2-C interface.

FIG. 4 shows U-plane (user plane) connectivity of eNBs involved in dual connectivity. FIG. 4 shows a S-GW 412 connected to MeNB 407 over a S1-U interface. MeNB 407 is connected to SeNB 418 via X2-U interface. Also, the S-GW 412 is connected to the SeNB 418 over a S1-U interface.

Typically in dual connectivity a UE is in RRC_CONNECTED mode of operation, and is configured with a master cell group (MCG) and a secondary cell group (SCG). For MCG bearers, the MeNB is U-plane connected to the S-GW via S1-U, and the SeNB is not involved in the transport of user plane data. For split bearers, the MeNB is U-plane connected to the S-GW via S1-U and in addition, the MeNB and the SeNB are connected via X2-U. For SCG bearers, the SeNB is directly connected with the S-GW via S1-U.

In single connectivity, load balancing (i.e. distributing load between cells and/or nodes) is based on resource status information exchange between eNBs. There are at least two parts associated with MLB (mobility load balancing).

First, the high loaded eNB triggers handover of the active UE to a light (or lighter) loaded eNB. This may not have significant impact, even in the case of dual connectivity. The handover of a dual connectivity UE can be triggered by SeNB “modification required” or SeNB “modification request” message defined in the base line change requests (CR). Currently base line CR for S1 AP, X2 AP and RAN 3 stage 2 are captured in R3-141972, R3-142044 and R3-141966.

Secondly, the handover thresholds are adjusted when the handover is triggered based on one or more measurement reports. Although the measurement thresholds need to be updated, there is currently no way to realise this aspect in dual connectivity which also considers single connectivity.

At least some embodiments of the present invention support MLB in dual connectivity, whilst also considering coexistence with single connectivity users.

In embodiments, the small cell nodes are capable of dual connectivity when required. The small cell nodes (i.e. SeNB) will trigger a request for change of handover thresholds to its neighbouring nodes, and may also send the request to the MeNB which has allocated resources to it as SeNB.

The “threshold” values corresponding to the serving cell and target cell may comprise signal strength measurement values at which a UE will trigger a measurement report indicating a need to change serving-cell. Based on the reports received from one or more UEs, the serving cell may trigger a handover procedure for those one or more UEs. For example, consider a situation where there are two cells, “Cell 1” and “Cell 2”. By reducing the threshold value at Cell 1, the handover from Cell 1 to Cell 2 will happen earlier (i.e. at a lower loading level). In the same way, if the threshold is increased then the handover from Cell 1 to Cell 2 will be triggered later (i.e. at a higher loading level). A node, such as an eNB (e.g. an SeNB) affected by a high cell-load, may trigger the request for the change of threshold.

In a first case, the affected node (e.g. SeNB) may trigger the request when it is reaching its maximum capacity. In such a case the request will be to reduce the cell-loading threshold value at which handover from the affected node occurs i.e. to cause UEs to handover to another node. Based on X2 messaging, the affected node may be aware of the capacity of its neighbouring nodes. In some embodiments the affected node can send the request to one or more selected neighbouring nodes. For example, the affected node may be aware of one or more neighbouring nodes that can withstand a higher load. The affected node may send the request to one or more of those nodes which can withstand a higher load. With the knowledge that one or more neighbouring nodes can withstand a higher load, the affected node (e.g. SeNB) may additionally or alternatively send the request to a controlling node, such as an MeNB.

An “affected node” (e.g. SeNB), may also wish to increase its cell-loading handover threshold (i.e. to allow a higher cell loading, and to allow UEs to connect or reconnect to the affected node). For example, the affected node may be recovering to a normal loading condition following a period of high loading (which period of high loading may have caused a reduction in the threshold). The affected node may in this case send a request to neighbouring nodes (e.g. SeNBs) and/or to a controlling node (e.g. MeNB) to increase the threshold level.

By analogy, it may therefore be considered that a node which is heavily loaded requests its neighbouring nodes to increase their cell radius, and a node which is lightly loaded requests its neighbouring nodes to reduce their cell radius.

The request for change message to the MeNB may also have an additional indication that the message is meant for SCG mobility. This indication may also be sent as a separate message. On reception of the message, the MeNB may change the threshold values for the mobility between the source and target-cells. The MeNB may also change threshold values for other cells, as a result of the request for change. In the case of intra-SeNB load balancing for dual connectivity, the message may be triggered from SeNB towards MeNB.

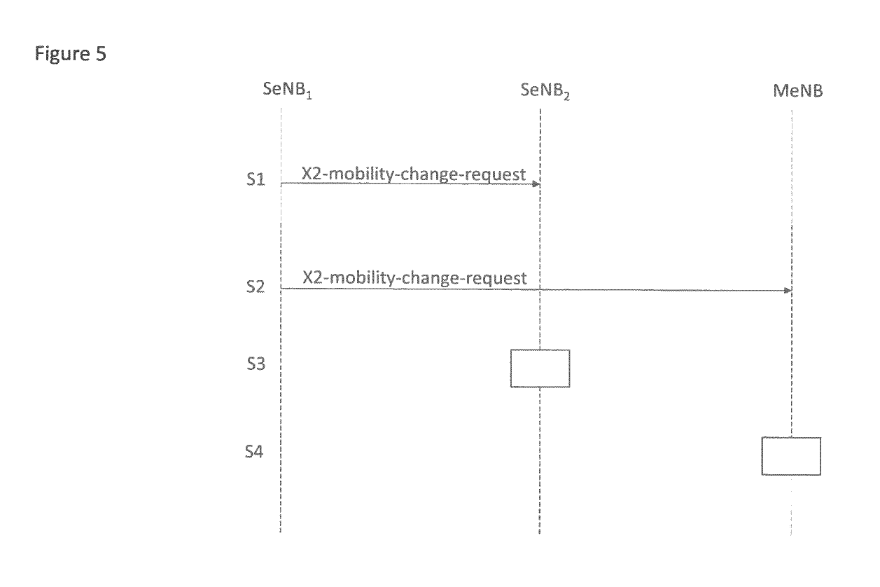

An embodiment for inter-SeNB mobility load balancing is explained in more detail with respect to the signalling diagram of FIG. 5. At step S1, SeNB₁ sends an X2 mobility change request to its neighbour SeNB₂, so that it can adjust the handover threshold. At step S2 the SeNB₁ also sends the same message to its connected MeNB, so that the MeNB can consider changing the thresholds of SCG mobility between the given cells, as per the request. The message sent at steps S2 may also indicate that the request is applicable for SCG change. In some embodiments the message may indicate that it is applicable for SCG change only.

At step S3 the SeNB₂ changes the handover threshold in accordance with the request of step S1. At step S4 the MeNB changes the handover threshold in accordance with the message received at step S2.

It will be understood that the order of the steps of FIG. 5 is by way of example only, and that the steps may be carried out in a different order. For example the mobility change request could be sent to the MeNB before being sent to the SeNB₂ (i.e. step S2 could occur before step S1). Also, the thresholds may be updated at one node before the change request is sent to another node (e.g. step S3 could occur before step S2).

In some embodiments, in order to check whether the target SeNB (i.e. SeNB₂) is also connected to the same MeNB, the X2 message between SeNB₁ and SeNB₂ may also exchange associated MeNB information. In some embodiments this is done by eNB configuration update message. Alternatively, the sending node SeNB₁ can send this message blindly to the target SeNB (SeNB₂) and also to its MeNB (if it knows the list of SeNBs of SeNB cluster via OAM means).

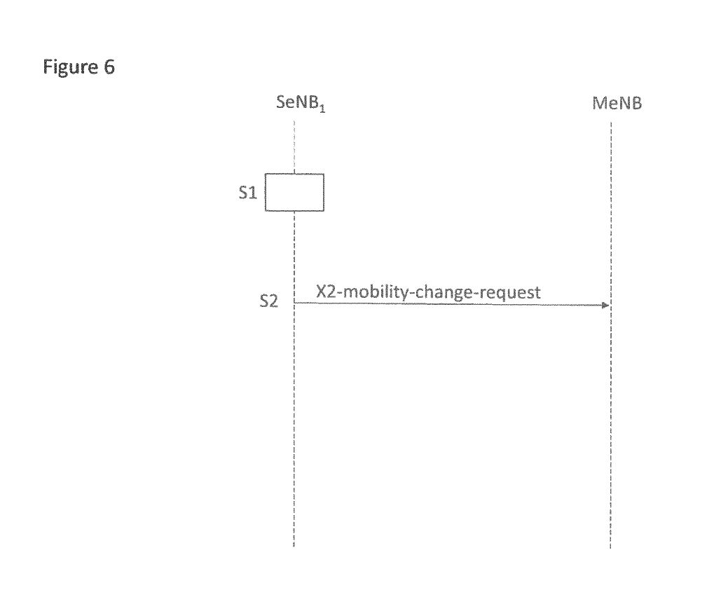

An intra-SeNB or intra-SeNB-controller mobility scenario is explained in more detail with respect to FIG. 6. The embodiment of FIG. 6 considers a scenario where the load balancing needs to be triggered between the cells (S cells) of the same SeNB, or between the small cell access points (APs) connected with a small cell controller (e.g. a SeNB controller). The small cell controller may act as SeNB for all the small cell APs.

At step S1 the SeNB₁ (small cell controller) modifies the handover thresholds against the source and target cells internally, and applies these thresholds to all active UEs connected to it directly as single connectivity UEs. As shown at step S2, for active UEs connected to the small cells APs as dual connectivity, the small cell controller SeNB₁ sends X2 mobility change request to the MeNB. The message sent at S2 may also comprise an indication that the change is for SCG mobility. This indication may also be sent in a separate message.

Accordingly the load balancing actions may be triggered for dual connectivity UE and single connectivity UE in parallel. The embodiment of FIG. 6 may also provide a simplified mechanism for intra-SeNB load balancing with dual connectivity.

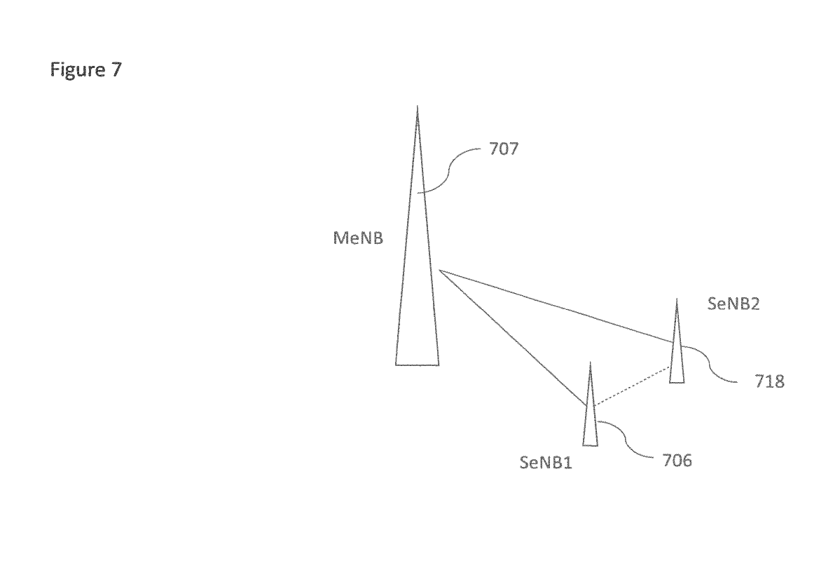

FIG. 7 shows in more detail a scenario of SeNBs of a SeNB cluster triggering load balancing. In the embodiment of FIG. 7 a MeNB is shown at 707. A first SeNB, SeNB₁ denoted 706, and a second SeNB, SeNB₂ denoted 718, are shown. There is an X2 interface shown by the dashed line between SeNB₁ 706 and SeNB₂ 718. There is also an X2 interface between the MeNB 707 and the SeNB₁ 706, and also an X2 interface between the MeNB 707 and the SeNB₂ 718. The X2 interfaces between the MeNB and SeNBs are shown by the solid lines.

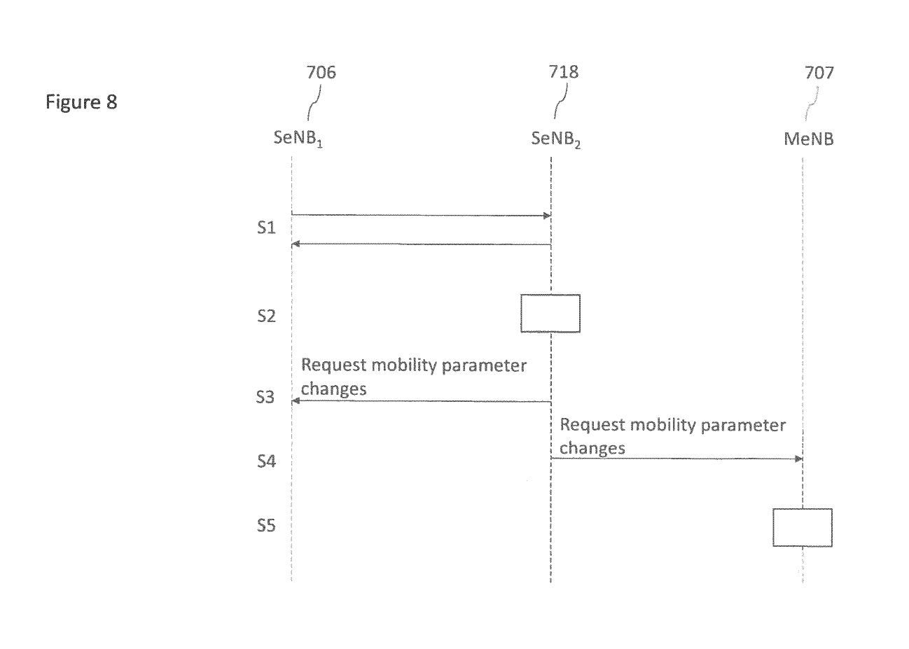

A signalling diagram associated with the architecture of FIG. 7 is shown in FIG. 8.

At step S1 there is an exchange of resource status data and load report data between SeNB₁ 706 and SeNB₂ 718.

At step S2 the SeNB₂ 718 decides that load balancing is required. Accordingly, at step S3 the SeNB₂ 718 sends to SeNB₁ 706 a request for mobility parameter change.

In a case of dual connectivity, the SeNB₂ also sends the request for mobility parameter change to MeNB 707, as shown at step S4. Then, at step S5 the MeNB 707 changes its threshold for SCG change accordingly. For example the MeNB may reduce its threshold for SCG change. This enables load balancing triggered from the source SeNB (SeNB₁ 706) for single connectivity UE, and also from MeNB 707 for dual connectivity UE.

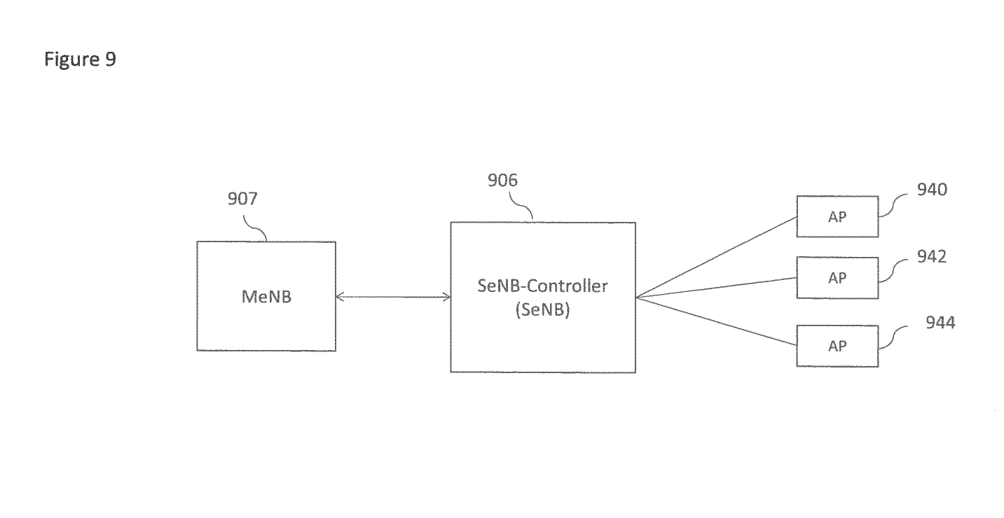

A scenario for when an SeNB-controller/SeNB wants to trigger load balancing between connected S-cells is shown in FIG. 9. In FIG. 9 the MeNB is shown at 907, and is connected to a SeNB controller 906. The SeNB controller 906 is configured for communication with access points (APs) 940, 942 and 944. In this embodiment UEs have dual connectivity with MeNB and one or more of the APs 940, 942 and 944. The APs are connected to the MeNB 907 via the SeNB controller 906.

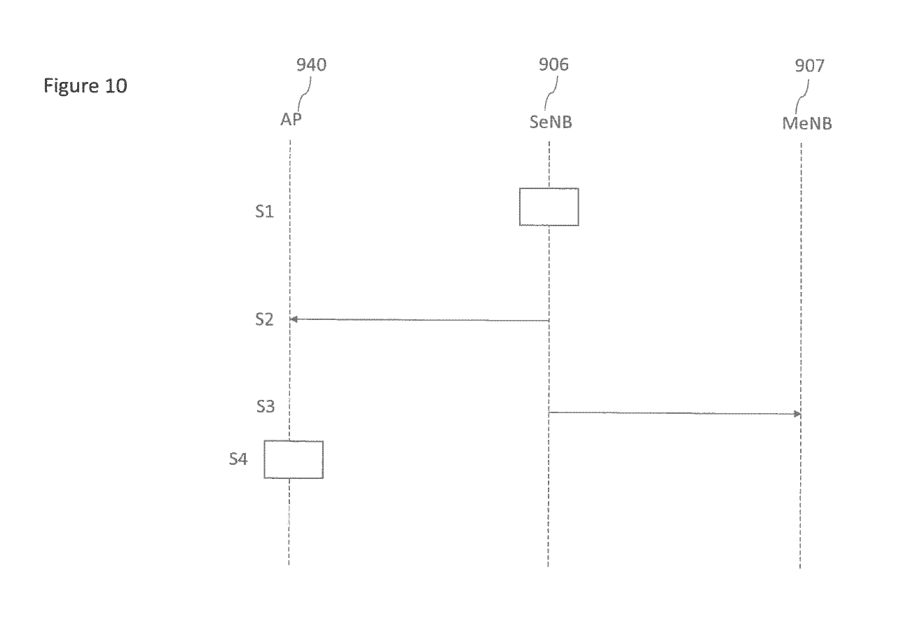

FIG. 10 is a signalling diagram associated with the architecture of FIG. 9. In FIG. 10, at step S1 the SeNB 906 decides to trigger load balancing between two or more of its APs (for simplicity one AP is shown at 940), as shown at step S1. Therefore, as shown at step S2 the SeNB 906 sends a message to one or more of the APs 940 to change the handover threshold. At step S3 the SeNB 906 also sends a message to MeNB 907 to change the handover threshold. The messages sent at steps S2 and S3 may be X2 mobility parameter change messages indicating that the message is meant for SCG mobility. At step S4 the APs can then apply the new thresholds.

In some embodiments the target SeNB modifies the threshold on reception of the instruction to do so, for UEs connected to it as single connectivity. The target SeNB may do this without authorisation from MeNB. For dual-connectivity UEs, the target SeNB may require authorisation from the MeNB before altering the threshold.

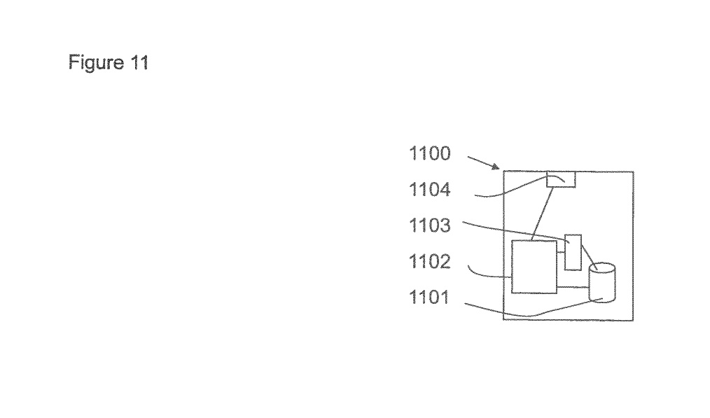

Embodiments described above by means of FIGS. 1 to 10 may be implemented on a control apparatus as shown in FIG. 11. FIG. 11 shows an example of a control apparatus for a communication system, for example to be coupled to and/or for controlling a station of an access system, such as a base station or (e) node B, or a server or host. In some embodiments, base stations comprise a separate apparatus unit or module. In other embodiments, the control apparatus can be another network element such as a radio network controller or a spectrum controller. In some embodiments, each base station may have such a control apparatus as well as a control apparatus being provided in a radio network controller. The control apparatus 1100 can be arranged to provide control on communications in the service area of the system. The control apparatus 1100 comprises at least one memory 1101, at least one data processing unit 1102, 1103 and an input/output interface 1104. Via the interface the control apparatus can be coupled to a receiver and a transmitter of the base station. The receiver and/or the transmitter may be implemented as a radio front end or a remote radio head. For example the control apparatus 1100 can be configured to execute an appropriate software code to provide the control functions. Although FIG. 11 shows one memory 1101 and two processors 1102 and 1103, any number of these components may be provided. Multiple functions may be carried out in a single processor, or separate functions may be carried out by separate processors. For example a single processor may be used to make multiple determinations, or separate determinations may be made by separate processors.

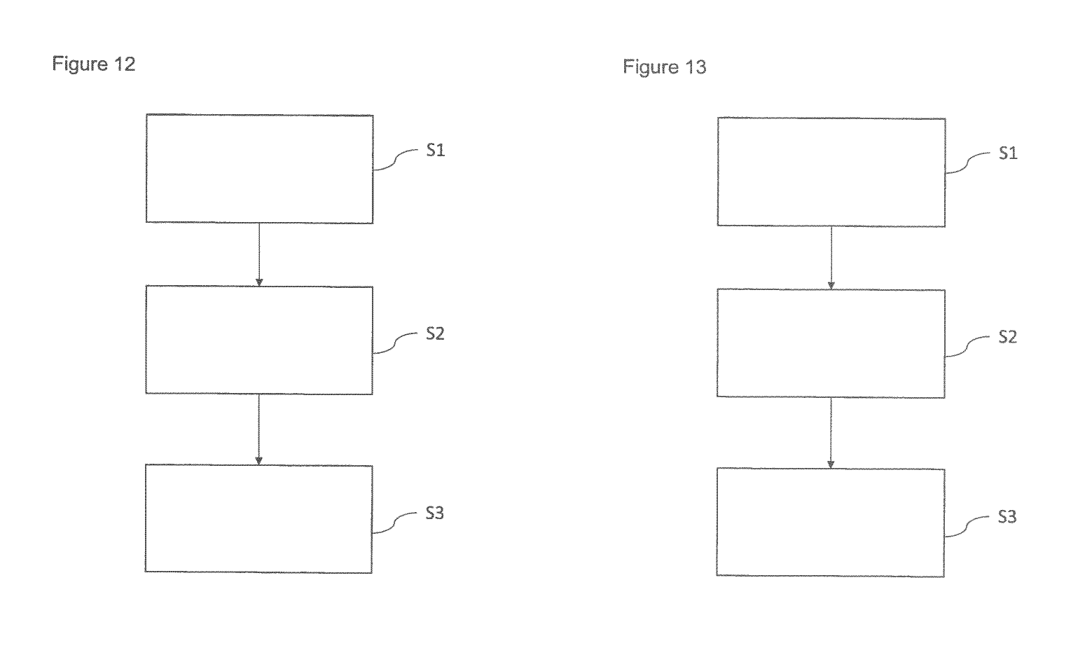

FIG. 12 shows steps of a method according to an embodiment. These steps may be carried out in a control apparatus as described with respect to FIG. 11. At step S1 at least one parameter associated with handover of one or more user equipment from a first node to at least one further node is stored. At step S2 a request for change of said parameter is sent from the first node. At step S3 the parameter is updated at the first node. The first node is configured for dual connectivity with one or more user equipment and a second node.

FIG. 13 shows steps of a method according to an embodiment. These steps may be carried out in a control apparatus as described with respect to FIG. 11. At step S1 at least one parameter associated with handover of one or more user equipment from a first node to at least one further node is stored at a node. At step S2 a request for change of said parameter is received from said first node. At step S3 said parameter is updated at said node. The node is configured for dual connectivity with one or more user equipment and a second node.

It should be understood that the apparatuses may include or be coupled to other units or modules etc., such as radio parts or radio heads, used in or for transmission and/or reception. Although the apparatuses have been described as one entity, different modules and memory may be implemented in one or more physical or logical entities.

It is noted that whilst embodiments have been described in relation to LTE, similar principles can be applied to any other communication system or radio access technology, where dual connectivity is supported. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments as described above by means of FIGS. 1 to 11 may be implemented by computer software executable by a data processor, at least one data processing unit or process of a device, such as a base station, e.g. eNB, or a UE, in, e.g., the processor entity, or by hardware, or by a combination of software and hardware. Computer software or program, also called program product, including software routines, applets and/or macros, may be stored in any apparatus-readable data storage medium or distribution medium and they include program instructions to perform particular tasks. An apparatus-readable data storage medium or distribution medium may be a non-transitory medium. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments described above in relation to FIGS. 1 to 7 may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims. Indeed there is a further embodiment comprising a combination of one or more embodiments with any of the other embodiments previously discussed.

1. A method comprising:
storing, at a first node, at least one parameter associated with handover of one or more user equipment from said first node to at least one further node;
causing to be sent, from said first node, a request for change of said parameter; and updating said parameter at said first node;
wherein said first node is configured for dual connectivity with one or more user equipment and a second node.

2. A method as set forth in claim 1, wherein said first node comprises a base station controlling a first secondary cell, and said second node comprises a base station controlling a master cell.

3. A method as set forth in claim 2, wherein said at least one further node comprises a base station controlling a second secondary cell.

4. A method as set forth in claim 3, wherein said parameter comprises a cell-loading threshold.

5. A method as set forth in claim 4, wherein said updating said parameter comprises one of: reducing said cell-loading threshold; increasing said cell-loading threshold.

6. A method as set forth in claim 3, wherein said request is sent to at least one of: said at least one further node; said second node.

7. A method comprising:
storing, at a node, at least one parameter associated with handover of one or more user equipment from a first node to at least one further node;
receiving, from said first node, a request for change of said parameter;
and updating said parameter at said node;
wherein said node is configured for dual connectivity with one or more user equipment and a second node.

8. A method as set forth in claim 7, wherein said node at which said parameter is stored comprises one of: said at least one further node; said second node.

9. A method as set forth in claim 8, wherein said at least one further node comprises a base station controlling a second secondary cell, and said second node comprises a base station controlling a master cell.

10. A method as set forth in 9 claim 9, wherein said parameter comprises a cell-loading threshold.

11. A method as set forth in claim 10, wherein said updating said parameter comprises one of: reducing said cell-loading threshold; increasing said cell-loading threshold.

12. A method as set forth in claim 9, comprising sending a response to said request authorizing said requested change of said parameter.

13. A computer program product comprising a non-transitory computer-readable storage medium bearing computer program code embodied therein for use with a computer, the computer program code comprising code for performing the method of claim 1.

14. An apparatus comprising
at least one processor;
and at least one memory including computer program code;
the at least one memory and the computer program code configured to, with the at least one processor, cause the apparatus at least to:
store at least one parameter associated with handover of one or more user equipment from said apparatus to at least one further node;
cause to be sent, from said apparatus, a request for change of said parameter; and update said parameter at said apparatus;
wherein said apparatus is configured for dual connectivity with one or more user equipment and a second node.

15.-19. (canceled)

20. An apparatus comprising
at least one processor;
and at least one memory including computer program code;
the at least one memory and the computer program code configured to, with the at least one processor, cause the apparatus at least to:
store at least one parameter associated with handover of one or more user equipment from a first node to at least one further node;
receive, from said first node, a request for change of said parameter;
and update said parameter at said apparatus;
wherein said apparatus is configured for dual connectivity with one or more user equipment and a second node.

21.-25. (canceled)

26. A computer program product comprising a non-transitory computer-readable storage medium bearing computer program code embodied therein for use with a computer, the computer program code comprising code for performing the method of claim 7.
